(19) United States
(12) Patent Application Publication
(10) Pub. No.: US 2026/0125061 A1
(43) Pub. Date: May 7, 2026

(54) AUTOMATIC BEHAVIOR DECISION MAKING AT INTERSECTIONS

(71) Applicant: Torc Robotics, Inc., Blacksburg, VA (US)

(72) Inventors: Margarita Kunjavskaja, Stuttgart (DE); Maximilian Yassine Beyen, Leutenbach (DE); Simon Baeuerle, Hesse (DE); Maximilian Koeper, Ostfildern, Baden-Wurttemberg (DE); Marat Kopytjuk, Heilbronn (DE)

(21) Appl. No.: 18/936,331

(22) Filed: Nov. 4, 2024

(51) Int. Cl. B60W 30/18; B60W 60/00

(52) U.S. Cl. CPC B60W 30/18159; B60W 60/001; B60W 2554/4045; B60W 2556/65; B60W 2756/10

(57) ABSTRACT

In one aspect, the disclosed method for determining a right-of-way at an intersection includes receiving, from one or more sensors associated with an autonomous vehicle, an indication that the autonomous vehicle is approaching an intersection. The disclosed method may further include transmitting, in response to the indication, a first set of data associated with a position of the autonomous vehicle relative to the intersection and receiving a second set of data from one or more other vehicles. The second set of data may be associated with one or more positions of the one or more other vehicles relative to the intersection. The disclosed method may further include determining an order based on the first set of data and the second set of data. The order may include the autonomous vehicle and the one or more other vehicles, which may be associated with a status.

### TECHNICAL FIELD

The field of the disclosure relates generally to autonomous vehicles and, more specifically, determining a right-of-way at an intersection in an autonomous vehicle.

### BACKGROUND OF THE INVENTION

At intersections, determining right-of-way is essential to managing traffic flow and preventing accidents. Different countries use various methods to establish which vehicle should proceed first at four-way stop intersections, and autonomous vehicles must be capable of adapting to these varying rules and practices. In the U.S., right-of-way at a four-way stop is typically granted to the first vehicle to arrive. If two vehicles arrive simultaneously, the vehicle on the right has the right-of-way. In some European countries, such as Germany, the general rule is “priority to the right” (right-before-left), where vehicles approaching from the right have the right-of-way unless otherwise indicated by signs. Similarly, in the UK, vehicles at unmarked intersections give priority to the right, but roundabouts, a common type of intersection, grant right-of-way to vehicles already in the roundabout.

Autonomous vehicles should employ fundamental technologies such as, perception, localization, behaviors and planning, and control at intersections to determine a right-of-way. As the adoption of autonomous driving technologies expands across borders, addressing these differences in right-of-way determination is crucial to ensure safe and efficient navigation at intersections globally. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed method for determining a right-of-way at an intersection includes receiving, from one or more sensors associated with an autonomous vehicle, an indication that the autonomous vehicle is approaching an intersection. The disclosed method may further include transmitting, in response to the indication, a first set of data associated with a position of the autonomous vehicle relative to the intersection and receiving a second set of data from one or more other vehicles. The second set of data may be associated with one or more positions of the one or more other vehicles relative to the intersection. The disclosed method may further include determining an order based on the first set of data and the second set of data. The order may indicate a sequence for proceeding through the intersection and may include the autonomous vehicle and the one or more other vehicles. The autonomous vehicle and the one or more other vehicles may be associated with a status.

In another aspect, the disclosed method may also include transmitting the order to the one or more other vehicles. In another aspect, the disclosed method may also include monitoring, using the one or more sensors, the status of the one or other vehicles associated with the order, and updating the status of the one or more other vehicles based on a third set of data received from the one or more sensors. In another aspect, the status may indicate a current posture of a vehicle associated with the order.

In another aspect, the disclosed method may also include transmitting instructions that include a command to proceed through the intersection, where the instructions are transmitted when the status of the one or more vehicles in the sequence that precede the autonomous vehicle in the sequence indicate completion of the intersection. In another aspect, the disclosed method may also include transmitting signal instructions that include a command to present a human-perceptible signal that the autonomous vehicle is preparing to proceed through the intersection. In another aspect, the disclosed method may also include transmitting signal instructions that include a commend to transmit a notification to the one or more vehicles indicating that the autonomous vehicle is preparing to proceed through the intersection.

In another aspect, the disclosed method may also include receiving a notification from a vehicle of the one or more vehicles indicating that the vehicle is preparing to proceed through the intersection, and updating the status associated with the vehicle based on the notification. In another aspect, the disclosed method may also include updating the order based on a change in status of the one or more vehicles. Other technical features may be readily apparent to one skilled in the art from the following figures, descriptions, and claims.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck according to some aspects of the present disclosure.

FIG. 2 is a block diagram of the autonomous truck shown in FIG. 1 according to some aspects of the present disclosure.

FIG. 3 is a block diagram of one embodiment of an intersection module according to some aspects of the present disclosure.

FIG. 4 is a flowchart of an embodiment method for determining a right-of-way at an intersection in an autonomous vehicle using an intersection module according to some aspects of the present disclosure.

FIG. 5 is a block diagram of an example computing system for executing an intersection module according to some aspects of the present disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Autonomous vehicles are required to abide by applicable traffic laws, include right-of-way regulations at intersections with stop signs (e.g., not stoplights or intersections managed by a traffic control individual). A methodology can be implemented within autonomous vehicles to address an intersection and determine how to proceed through an intersection, thereby avoiding major material and immaterial losses. To do so, an autonomous vehicle may gather data pertaining to a position of the autonomous vehicle relative to the intersection and data pertaining to respective positions of one or more other vehicles relative to the intersection. Using this data, the autonomous vehicle may generate a list that includes the autonomous vehicle and the one or more other vehicles indicating in what order the autonomous vehicle and the one or more vehicles should proceed through the intersection. In some examples, the autonomous vehicle may transmit and receive signals indicating positions, intentions, status, updates, any combination thereof, or the like, that may impact the list and the order of procession. By dynamically updating the list according to received signals, and by conducting vehicle-to-vehicle communication, an effective and efficient methodology may be implemented to safely interact with an intersection.

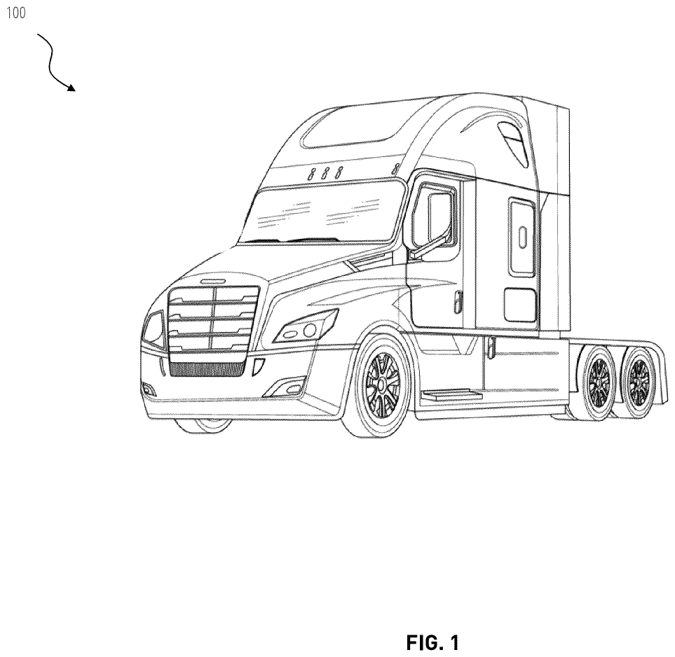

FIG. 1 illustrates a vehicle 100, such as a truck that may be conventionally connected to a single or tandem trailer to transport the trailer (not shown) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of the cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

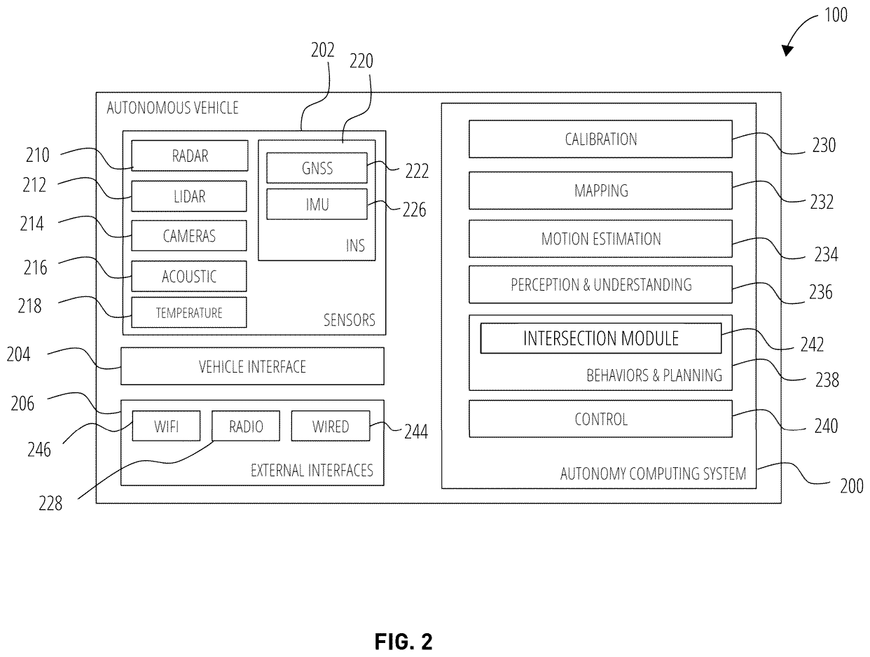

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 226. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 226 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 226 may measure an acceleration, angular rate, or an orientation of autonomous vehicle 100 or one or more of its individual components using a combination of accelerometers, gyroscopes, or magnetometers. IMU 226 may detect linear acceleration using one or more accelerometers and rotational rate using one or more gyroscopes and attitude information from one or more magnetometers. In some embodiments, IMU 226 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 246 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an intersection module 242. The intersection module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The intersection module 242 may perform one or more tasks including, but not limited to determining a position associated with autonomous vehicle 100 and/or other vehicles associated with an intersection, identify an appropriate sequence according to the position, generate one or more communications to transmit between vehicles associated with the intersection, receive and process sensor data from sensors 202, transmit instructions to autonomy computing system 200, any combination thereof, or the like.

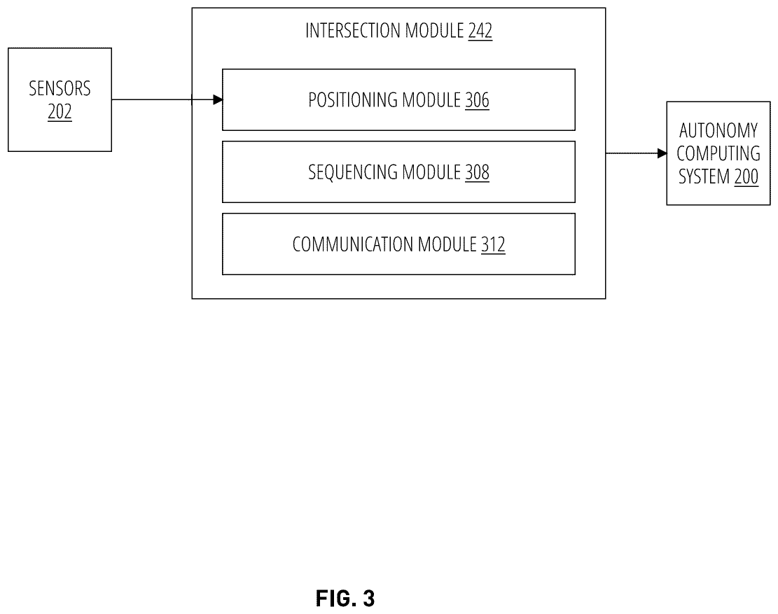

FIG. 3 is a block diagram of one embodiment of an intersection module according to some aspects of the present disclosure. Intersection module 242 may instruct an autonomous vehicle (e.g., autonomous vehicle 100 as described in FIG. 1) when the autonomous vehicle is approaching an intersection. In some examples, the intersection may be a three or four-way stop, where there is no traffic signal (e.g., a stop light, traffic control individual, etc.) indicating an order in which vehicles should proceed through the intersection. For example, if two vehicles are stopped at the intersection, the standard rule in American traffic laws is that the car that approaches the intersection first, has right-of-way. Thus, the autonomous vehicle may require intersection module 242 to ensure that this standard is implemented in driving habits and commands.

Intersection module 242 may include one or more internal components, including, but not limited to, positioning module 306, sequencing module 308, and communication module 312. These internal components may operate alone or in conjunction with one another to perform any and/or all of the functions of intersection module 242. In some examples, intersection module 242 may be communicatively coupled to external components of intersection module 242, including, but not limited to, sensors 202, autonomy computing system 200, external interfaces 206, and/or any other electronic component included within autonomous vehicle 100.

Over the duration of a trip, autonomous vehicle 100 may utilize one or more sensors (e.g., sensors 202) to receive input regarding obstacles, road markings, speed, temperature, other vehicles, road conditions, road regulations (e.g., construction zones, school zones, speed limits, lane closures, etc.), cross walks, intersections (e.g., three-way, four-way, stop lights, stop signs, yields, merge lanes, etc.), pedestrians, any combination thereof, or the like. The one or more sensors may include an accelerometer, camera, proximity sensor, light sensor, global positioning system, gyroscope, radar sensor, any and/or all of the sensors of sensors 202, any combination thereof, or the like. In some examples, sensors 202 may transmit data to intersection module 242. Using sensor data from sensors 202, intersection module 242 may determine that autonomous vehicle 100 is approaching an intersection without a traffic signal (e.g., a stop light, traffic control individual, any combination thereof, or the like).

In some examples, positioning module 306 may determine a position of autonomous vehicle 100 relative to the intersection. The position may include a current distance (e.g., how far away autonomous vehicle 100 is from the intersection), a current speed, a current acceleration (e.g., rate of deceleration of autonomous vehicle 100), an expected arrival time at the intersection (e.g., how long it will take for autonomous vehicle 100 to arrive at a stop at the intersection), any combination thereof, or the like. Positioning module 306 may update the position of autonomous vehicle 100 in real-time as data is received from sensors 202 (e.g., a first set of data) pertaining to the position of autonomous vehicle 100. In some examples, the position of autonomous vehicle 100 may be stored in a location accessible to intersection module 242. For example, the position may be stored in a cache, a local database, a cloud database, any combination thereof, or the like. In some examples, positioning module 306 may transmit the position of autonomous vehicle 100 to the one or more vehicles via communication module 312.

Positioning module 306 may also determine a position of one or more other vehicles associated with the intersection. The one or more other vehicles may be autonomous vehicles, semi-autonomous vehicles, and/or non-autonomous vehicles (e.g., conventional vehicles and/or driven/operated by a human). For example, a first vehicle and a second vehicle may also be approaching the intersection at a similar time as autonomous vehicle 100. In some other examples, one or more other vehicles may already be stopped at the intersection, in the process of proceeding through the intersection, or have already driven through the intersection and are currently moving away from the intersection. Positioning module 306, similar to the data gathered pertaining to autonomous vehicle 100, may receive (via sensors 202) and store data (e.g., a second set of data) for the one or more vehicles associated with the intersection.

Positioning module 306 may determine respective positions for the one or more vehicles associated with the intersection, which may include a distance from the intersection, a current speed, a current acceleration, an expected arrival time at the intersection, any combination thereof, or the like. Positioning module 306 may also store the respective positions of the one or more vehicles in the location accessible to intersection module 242. The respective positions may also be updated in real-time as additional data is received at positioning module 306.

In some examples, positioning module 306 may receive one or more positions from the one or more vehicles in the form of a transmission, signal, notification, any combination thereof, or the like. Positioning module may receive data from a computing module associated with the one or more vehicles that may indicate a current distance (e.g., how far away autonomous vehicle 100 is from the intersection), a current speed, an current acceleration (e.g., rate of deceleration of autonomous vehicle 100), an expected arrival time at the intersection (e.g., how long it will take for autonomous vehicle 100 to arrive at a stop at the intersection), any combination thereof, or the like, of the one or more vehicles. Positioning module 306 may also store the received respective positions of the one or more vehicles in the location accessible to intersection module 242.

Sequencing module 308 may receive the position of autonomous vehicle 100 and one or more respective positions associated with the one or more vehicles from positioning module 306. Based on the position of autonomous vehicle 100 and/or the one or more respective positions of the one or more vehicles, sequencing module 308 may generated an ordered list indicating a sequence for the vehicles approaching the intersection to proceed through the intersection. The ordered list may be generated according to applicable laws associated with a geo-location of the intersection. For example, the ordered list may be sequenced according to the “right-before-left” guidelines that apply in Germany, or may be sequenced according to time of approach (e.g., when a vehicle reached the intersection) according to the guidelines that apply in the United States. The sequence may indicate which vehicle may proceed through the intersection first, then which vehicle may proceed second, and proceed sequentially until the vehicles at the intersection within a threshold time frame as autonomous vehicle 100 (e.g., approaching the intersection at a similar time, already stopped at the intersection while autonomous vehicle 100 approaches the intersection, approaching the intersection after autonomous vehicle 100 has already stopped at the intersection, approaching and/or stopped at the intersection while autonomous vehicle 100 is proceeding through the intersection, etc.) have proceeded through the time frame. In some examples, sequencing module 308 may sequence the ordered list such that autonomous vehicle 100 is last in the sequence, autonomous vehicle 100 may be first in the sequence, or autonomous vehicle 100 may be in the middle of the sequence (e.g., vehicles may proceed before autonomous vehicle 100 and after autonomous vehicle 100).

The one or more vehicles associated with the ordered list, including autonomous vehicle 100, may be associated with a status. The status may indicate a current posture of a vehicle relative to the intersection. For example, the status may be “waiting,” “proceeding,” “moving,” “active,” “pending,” “complete,” any combination thereof, or the like. In some examples, the status may be signaled by the one or more vehicles associated with the ordered list. In some other examples, the status may be determined by autonomous vehicle 100 (e.g., by positioning module 306 receiving a third set of data and identifying a change in speed, acceleration, position, any combination thereof, or the like associated with a vehicle of the one or more vehicles). The status associated with the one or more vehicles may change dynamically as data is received, such as an update in status from a vehicle of the one or more vehicles and/or a determination that a vehicle has moved from positioning module 306. In some examples, if the status of a vehicle of the one or more vehicles changes in a manner that does not correspond to the sequence associated with the ordered list, the ordered list may be dynamically updated according to the change in status. For example, if a vehicle proceeds through the intersection out of sequence (e.g., status should be “waiting,” but is instead “proceeding”), the sequence of the ordered list may be updated such that the vehicle is automatically moved up the sequence. In a similar manner, if a vehicle is not proceeding through the intersection in the sequence (e.g., status should be “proceeding” but is instead “waiting”), the vehicle may be moved down the sequence automatically.

The ordered list may be transmitted to communication module 312 from sequencing module 308. In some examples, communication module 312 may signal the ordered list to the one or more vehicles associated with the ordered list. By signaling the ordered list to the one or more vehicles, this may increase safety of all vehicles (and potential passengers) by ensuring that the one or more vehicles associated with the ordered list (and/or the intersection) can receive and/or process the ordered list for proper implementation. If there is a conflict with a second ordered list transmitted by another vehicle (e.g., another vehicle generates an ordered list with a sequence that differs from the sequence generated by autonomous vehicle 100), autonomous vehicle 100 and the other vehicle may identify the difference and determine which list will be implemented (e.g., according to policy, comparing data from one or more sensors to determine accuracy, any combination thereof, or the like). In some examples, communication module 312 may receive the position of autonomous vehicle 100 relative to the intersection from positioning module 306. Communication module 312 may transmit a position signal indicating the position of the autonomous vehicle to the one or more vehicles associated with the intersection.

Communication module 312 may transmit signals to the one or more vehicles indicating, according to the sequence of the ordered list, which vehicle may proceed through the intersection. For example, autonomous vehicle 100 may signal a first vehicle that the first vehicle may proceed through the intersection. In some examples, communication module 312 may signal autonomy computing system 200 that autonomous vehicle 100 may proceed through the intersection. In some examples, the one or more vehicles may transmit a response signal indicating that a vehicle of the one or more vehicles will begin proceeding through the intersection. The response signal may be distinct from or in combination with a signal indicating a change in status.

Communication module 312 may also transmit signals indicating a change of status associated with autonomous vehicle 100. The signals indicating a change in status may be a digital and/or analog signal (e.g., a transmission, data packet, RF signal, any combination thereof, or the like). In some examples, the signals may be a human-perceptible signal, such that it may be received by a human associated with a vehicle of the one or more vehicles. For example, the signals may be a turn signal associated with autonomous vehicle 100, flashing the headlights (e.g., turning on the “brights” momentarily before proceeding through the intersection), an audio announcement (e.g., a speaker outputs a sound and/or speaking announcement, honking a horn associated with autonomous vehicle 100), a digital sign, any combination thereof, or the like. In some examples, to output the human-perceptible signals generated from communication module 312, communication module 312 may transmit a command to autonomy computing system 200 to output the human-perceptible signal.

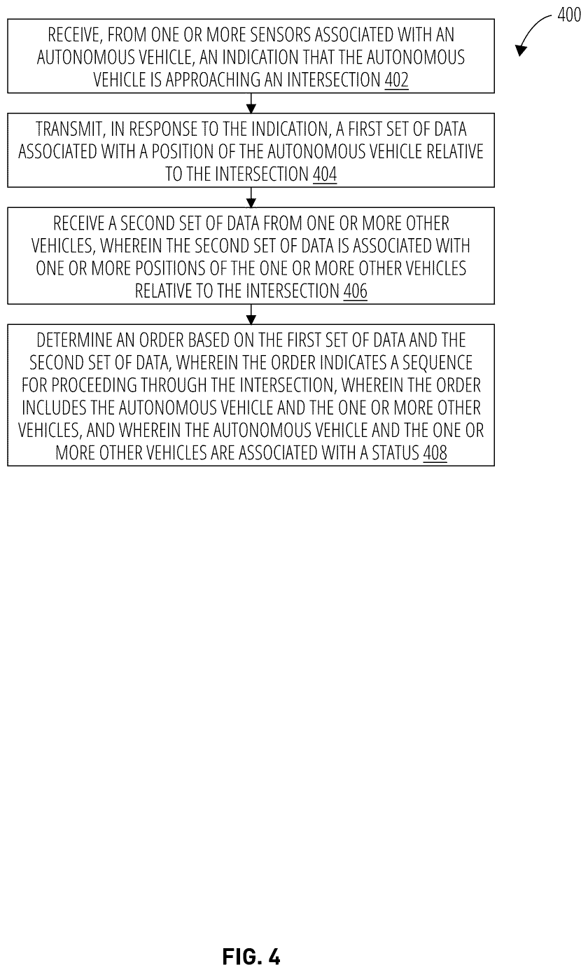

FIG. 4 illustrates an example method 400 for determining a right-of-way at an intersection in an autonomous vehicle using an intersection module. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

Method 400 includes receiving 402, from one or more sensors associated with an autonomous vehicle, an indication that the autonomous vehicle is approaching an intersection. For example, intersection module 242 (shown in FIG. 3) may receive 402, from sensors 202 (shown in FIG. 2), an indication that autonomous vehicle 100 (shown in FIG. 1) is approaching an intersection. An intersection module may process data from the one or more sensors (e.g., proximity sensors, cameras, LiDAR sensors, any combination thereof, or the like) and determine, based on the data, that the autonomous vehicle is approaching the intersection. The intersection may be a four-way stop, three-way stop, or any type of intersection that is not managed by a traffic signal and/or traffic control individual.

Method 400 includes transmitting 404, in response to the indication, a first set of data associated with a position of the autonomous vehicle relative to the intersection. For example, intersection module 242 may transmit 404, in response to the indication, a first set of data associated with a position of autonomous vehicle 100 relative to the intersection. The intersection module may transmit the first set of data to one or more other vehicles associated with the intersection (e.g., other vehicles that are currently stopped at the intersection, are approaching the intersection, are proceeding driving through the intersection, are past the intersection, any combination thereof, or the like). In some examples, the intersection module may transmit the data to an internal module (e.g., positioning module 306 and/or sequencing module 308 shown in FIG. 3) for processing. The position may include a current distance (e.g., how far away the autonomous vehicle is from the intersection), a current speed, an current acceleration (e.g., rate of deceleration of the autonomous vehicle), an expected arrival time at the intersection (e.g., how long it will take for the autonomous vehicle to arrive at a stop at the intersection), any combination thereof, or the like.

Method 400 includes receiving 406 a second set of data from one or more other vehicles, wherein the second set of data is associated with one or more positions of the one or more other vehicles relative to the intersection. For example, intersection module 242 may receive 406 a second set of data from one or more other vehicles, wherein the second set of data is associated with one or more positions of the one or more other vehicles relative to the intersection. This data may include a current distance (e.g., how far away the one or more other vehicles are from the intersection), a current speed, an current acceleration (e.g., rate of deceleration of the one or more other vehicles), an expected arrival time at the intersection (e.g., how long it will take for the one or more other vehicles to arrive at a stop at the intersection), any combination thereof, or the like. In some examples, the intersection module may transmit the data to an internal module (e.g., sequencing module 308) for processing.

Method 400 includes determining 408 an order based on the first set of data and the second set of data, wherein the order indicates a sequence for proceeding through the intersection, wherein the order includes the autonomous vehicle and the one or more other vehicles, and wherein the autonomous vehicle and the one or more other vehicles are associated with a status. For example, intersection module 242 may determine 408 an order based on the first set of data and the second set of data, wherein the order indicates a sequence for proceeding through the intersection, wherein the order includes the autonomous vehicle 100 and the one or more other vehicles, and wherein the autonomous vehicle 100 and the one or more other vehicles are associated with a status. The status may indicate a current posture of a vehicle relative to the intersection. For example, the status may be “waiting,” “proceeding,” “moving,” “active,” “pending,” “complete,” any combination thereof, or the like. In some examples, the status may be signaled by the one or more vehicles associated with the ordered list. In some other examples, the status may be determined by the intersection module (e.g., by identifying a change in speed, acceleration, position, any combination thereof, or the like associated with a vehicle of the one or more vehicles). In some examples, the order may be signaled to the one or more other vehicles.

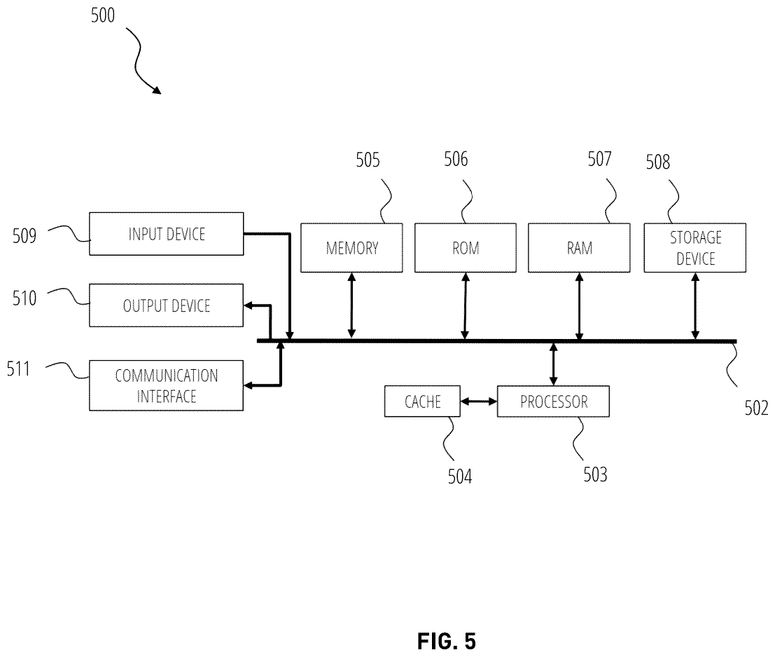

FIG. 5 illustrates an example computing system 500 that can implement various techniques, processes, functions, or methods described herein. The components of computing system 500 are shown in electrical communication with each other using a connection 502, such as a bus. The example computing system 500 includes a processing unit (or processor) 503 and a computing device connection 501 that couples various computing device components, including computing device memory 505, such as a read only memory ROM 506 and a random access memory RAM 507, to processor 503.

Computing system 500 can include a cache 504 of high-speed memory connected directly with, in close proximity to, or integrated as part of processor 810. Computing system 500 can copy data from memory 505 and/or storage device 508 to cache 504 for quick access by processor 503. In this way, cache 504 can provide a performance boost that avoids processor 503 delays while waiting for data. These and other modules can control or be configured to control processor 503 to perform various actions. Other computing device memory 505 may be available for use as well. Memory 505 can include multiple different types of memory with different performance characteristics. Processor 503 can include any general purpose processor, central processing unit (CPU), or graphics processing unit (GPU) in combination with a hardware or software provision configured to control processor 503 and stored in storage device 508, as well as any special-purpose processor where software instructions are incorporated into the processor design. Processor 503 may be a self-contained system, containing multiple cores or processors, a bus, memory controller, cache, etc. A multi-core processor may be symmetric or asymmetric.

Storage device 508 is a non-volatile memory and can be one or more of a hard disk or other types of computer readable media that can store data that are accessible by a computer, such as a magnetic cassette, flash memory card, solid state memory device, digital versatile disk, cartridge, RAM 507, ROM 506, or hybrids thereof. Memory 505 or storage device 508 can include software, code, firmware, etc., for controlling processor 503. Other hardware or software modules are contemplated. Memory 505 and storage device 508 are connected to computing device connection 501. In one aspect, a hardware module that performs a particular function can include the software component stored in a computer-readable medium in connection with the necessary hardware components, such as processor 503, computing device connection 501, and so forth, to carry out the function. In the example embodiment, processor 503 may be programmed by encoding an operation or function using one or more executable instructions and providing the executable instructions in memory 505 or storage device 508.

To enable user interaction, computing system 500 includes an input device 509, which can represent any number of input mechanisms, such as a microphone for speech, a touch-sensitive screen for gesture or graphical input, keyboard, mouse, motion input, speech, etc. Computing system 500 can also include output device 510, which can be one or more of a number of output mechanisms known to those of skill in the art. In some instances, multimodal systems can enable a user to provide multiple types of input/output to communicate with computing system 500. Computing system 500 can include communication interface 511, which can generally govern and manage the user input and system output. There is no restriction on operating on any particular hardware arrangement, and therefore the basic features here may easily be substituted for improved hardware or firmware arrangements as they are developed.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) improving safety for vehicles and passengers by implementing a methodology for intersections, (b) allowing for compliance and adaptability based on laws or guidelines associated with a present geolocation of an autonomous vehicle, (c) improving safety by incorporating clear signaling indicating the intended actions of an autonomous vehicle, and/or (d) improving computational efficiency by utilizing signaling from external sources (e.g., other vehicles) to determine position and intentions rather than solely relying on internal sensors.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A method for determining a right-of-way at an intersection, comprising:
receiving, from one or more sensors associated with an autonomous vehicle, an indication that the autonomous vehicle is approaching an intersection;
transmitting, in response to the indication, a first set of data associated with a position of the autonomous vehicle relative to the intersection;
receiving a second set of data from one or more other vehicles, wherein the second set of data is associated with one or more positions of the one or more other vehicles relative to the intersection; and
determining an order based on the first set of data and the second set of data, wherein the order indicates a sequence for proceeding through the intersection, wherein the order includes the autonomous vehicle and the one or more other vehicles.

2. The method of claim 1, further comprising:
transmitting the order to the one or more other vehicles.

3. The method of claim 1, wherein the autonomous vehicle and the one or more other vehicles are associated with a status, and wherein the status indicates a current posture of a vehicle associated with the order.

4. The method of claim 3, further comprising:
monitoring, using the one or more sensors, the status of the one or more other vehicles associated with the order; and
updating the status of the one or more other vehicles based on a third set of data received from the one or more sensors.

5. The method of claim 4, further comprising:
transmitting instructions that include a command to proceed through the intersection, wherein the instructions are transmitted when the status of the one or more other vehicles in the sequence that precede the autonomous vehicle in the sequence indicate completion of the intersection.

6. The method of claim 1, further comprising:
transmitting signal instructions that include a command to present a human-perceptible signal that the autonomous vehicle is preparing to proceed through the intersection.

7. The method of claim 1, further comprising:
transmitting signal instructions that include a command to transmit a notification to the one or more other vehicles indicating that the autonomous vehicle is preparing to proceed through the intersection.

8. The method of claim 3, further comprising:
receiving a notification from a vehicle of the one or more other vehicles indicating that the vehicle is preparing to proceed through the intersection; and
updating the status associated with the vehicle based on the notification.

9. The method of claim 8, further comprising:
updating the order based on a change in status of the one or more other vehicles.

10. A system comprising:
one or more processors; and
a memory storing instructions that, when executed by the one or more processors, configure the system to:
receive, from one or more sensors associated with an autonomous vehicle, an indication that the autonomous vehicle is approaching an intersection;
transmit, in response to the indication, a first set of data associated with a position of the autonomous vehicle relative to the intersection;
receive a second set of data from one or more other vehicles, wherein the second set of data is associated with one or more positions of the one or more other vehicles relative to the intersection; and
determine an order based on the first set of data and the second set of data, wherein the order indicates a sequence for proceeding through the intersection, wherein the order includes the autonomous vehicle and the one or more other vehicles.

11. The system of claim 10, wherein the instructions further configure the system to:
transmit the order to the one or more other vehicles.

12. The system of claim 10, wherein the autonomous vehicle and the one or more other vehicles are associated with a status, and wherein the status indicates a current posture of a vehicle associated with the order.

13. The system of claim 12, wherein the instructions further configure the system to:
monitor, using the one or more sensors, the status of the one or more other vehicles associated with the order; and
update the status of the one or more other vehicles based on a third set of data received from the one or more sensors.

14. The system of claim 13, wherein the instructions further configure the system to:
transmit instructions that include a command to proceed through the intersection, wherein the instructions are transmitted when the status of the one or more other vehicles in the sequence that precede the autonomous vehicle in the sequence indicate completion of the intersection.

15. The system of claim 10, wherein the instructions further configure the system to:
transmit signal instructions that include a command to present a human-perceptible signal that the autonomous vehicle is preparing to proceed through the intersection.

16. The system of claim 10, wherein the instructions further configure the system to:
transmit signal instructions that include a command to transmit a notification to the one or more other vehicles indicating that the autonomous vehicle is preparing to proceed through the intersection.

17. The system of claim 12, wherein the instructions further configure the system to:
receive a notification from a vehicle of the one or more other vehicles indicating that the vehicle is preparing to proceed through the intersection; and
update the status associated with the vehicle based on the notification.

18. The system of claim 17, wherein the instructions further configure the system to:
update the order based on a change in status of the one or more other vehicles.

19. A non-transitory computer-readable storage medium, the non-transitory computer-readable storage medium including instructions that when executed by one or more processors, cause the one or more processors to:
receive, from one or more sensors associated with an autonomous vehicle, an indication that the autonomous vehicle is approaching an intersection;
transmit, in response to the indication, a first set of data associated with a position of the autonomous vehicle relative to the intersection;
receive a second set of data from one or more other vehicles, wherein the second set of data is associated with one or more positions of the one or more other vehicles relative to the intersection; and
determine an order based on the first set of data and the second set of data, wherein the order indicates a sequence for proceeding through the intersection, wherein the order includes the autonomous vehicle and the one or more other vehicles.

20. The non-transitory computer-readable storage medium of claim 19, wherein the autonomous vehicle and the one or more other vehicles are associated with a status, and wherein the instructions further configure the one or more processors to:
monitor, using the one or more sensors, the status of the one or more other vehicles associated with the order; and
update the status of the one or more other vehicles based on a third set of data received from the one or more sensors.
